(19) United States
(12) Patent Application Publication
(10) Pub. No.: US 2015/0142568 A1
(43) Pub. Date: May 21, 2015

(54) METHOD FOR ENABLING A MOBILE DEVICE TO GENERATE MESSAGE FEEDBACK, AND ADVERTISING SERVER IMPLEMENTING THE SAME CROSS-REFERENCE TO RELATED APPLICATION

(71) Applicant: MOBIINSIGHT CORPORATION, Taipei City (TW)

(72) Inventor: Shao-Feng HSU, Taipei City (TW)

(21) Appl. No.: 14/541,185

(22) Filed: Nov. 14, 2014

(30) Foreign Application Priority Data
Nov. 15, 2013 (TW) 102141698

(51) Int. Cl. G06Q 30/02; H04M 1/725

(52) U.S. Cl. CPC G06Q 30/0267; G06Q 30/0257; H04M 1/72552; H04M 1/72561
USPC 705/14.55; 705/14.64

(57) ABSTRACT

A method for enabling a mobile device to generate message feedback includes: receiving user agent data from a mobile device; calling a dynamic-link library, followed by analyzing the user agent data; based on a result of the analyzing, selecting a message launching command that conforms with the mobile device, a preset port number that is associated with the advertising server, and a preset text; and transmitting to the mobile device the message launching command, the preset port number, and the preset text. The message launching command configures the mobile device to launch a messaging application for creating a feedback message in which the preset port number and the preset text are automatically loaded.

### CROSS-REFERENCE TO RELATED APPLICATION

This application claims priority to Taiwanese Application No. 102141698, filed on Nov. 15, 2013.

### BACKGROUND OF THE INVENTION

1. Field of the Invention

The invention relates to a method for enabling a mobile device to generate message feedback, and more particularly to a method for enabling a mobile device to generate message feedback to mobile advertising, and an advertising server to implement the method.

2. Description of the Related Art

In the advertising industry, name-list-requiring host advertisers, such as the cram school industry, the insurance industry, the finance industry, the mobile industry, etc., are always searching for creative and high-quality sources of name lists, and then use a call center to make outbound calls to potential customers in the name list, thereby proceeding with sale activities or services to the potential customers.

In recent years, there has been significant growth in the use of internet advertisements to enhance advertising effect, for example, banner advertisements (banner ads) that are displayed in a webpage or a mobile application. When a user clicks/touches the banner ad on a computer or a mobile device, a browser may be launched to display an advertising webpage. The user (i.e., a potential consumer/customer) may fill personal information (e.g., a name) and contact information (e.g., a phone number) through the advertising webpage, followed by clicking a “send” button, so that advertisers may thereafter contact the consumer by phone according to the personal information and the contact information provided by the consumer. For example, a cram school may make arrangements with a potential customer by phone for further consulting and sales of lessons after obtaining the name list; an insurance company may contact a potential customer by phone and directly sell insurance product online after obtaining the name list; a financial service provider may promote credit card product to a potential customer by phone after obtaining the name list; and a car dealer may contact a potential customer by phone to arrange a test drive.

For the name-list requiring host advertisers, a call completion rate is a first-layer KPI (key performance indicator) of the obtained name list. However, the name lists obtained by the conventional advertising through the computers and mobile devices usually have the call completion rate KPI of about only 50% due to input of wrong phone/mobile phone number by users.

### SUMMARY OF THE INVENTION

Therefore, an object of the present invention is to provide a method that may allow a user who is interested in advertisements shown on a mobile device to send message feedback containing a phone number and preloaded content using a messaging function of the mobile device, thereby promoting accuracy of user-provided phone numbers and the call completion rate KPI.

According to one aspect of the present invention, a method is provided for enabling a mobile device to generate message feedback. The method is to be implemented by an advertising server, and comprises the steps of:

(a) receiving, from a mobile device, user agent data associated with the mobile device subsequent to a user trigger of a website link that is associated with the advertising server and that is loaded by the mobile device, the advertising server including a memory module that stores a dynamic-link library, the dynamic-link library containing a variety of message launching commands which respectively configure a variety of mobile devices to launch a corresponding messaging application;

(b) calling the dynamic-link library, followed by analyzing the user agent data from the mobile device;

(c) based on a result of the analyzing, selecting, from the memory module, one of the message launching commands that conforms with the mobile device, a preset port number that is associated with the website link, and a preset text; and

(d) transmitting to the mobile device the message launching command, the preset port number, and the preset text selected in step (c).

The message launching command configures the mobile device to launch a messaging application for creating a feedback message in which the preset port number is automatically loaded into a recipient field of the feedback message, and in which the preset text is automatically loaded into a content field of the feedback message.

Another object of the present invention is to provide an advertising server to implement the method of the present invention.

According to another aspect of the present invention, an advertising server comprises a memory module that stores a dynamic-link library, the dynamic-link library containing a variety of message launching commands which respectively configure a variety of mobile devices to launch a corresponding messaging application.

The advertising server is configured to:
receive, from a mobile device, user agent data associated with the mobile device subsequent to a user trigger of a website link that is associated with the advertising server and that is loaded by the mobile device;
call the dynamic-link library, followed by analyzing the user agent data from the mobile device;
based on a result of the analyzing, select, from the memory module, one of the message launching commands that conforms with the mobile device, a preset port number that is associated with the website link, and a preset text; and
transmit to the mobile device the message launching command, the preset port number, and the preset text thus selected.

The message launching command configures the mobile device to launch a messaging application for creating a feedback message in which the preset port number is automatically loaded into a recipient field of the feedback message, and in which the preset text is automatically loaded into a content field of the feedback message.

### BRIEF DESCRIPTION OF THE DRAWINGS

Other features and advantages of the present invention will become apparent in the following detailed description of an embodiment with reference to the accompanying drawings, of which:

FIG. 1 is a schematic diagram illustrating system architecture to implement an embodiment of a method for enabling a mobile device to generate message feedback according to the present disclosure; and

FIG. 2 is a flow chart illustrating steps of the embodiment.

### DETAILED DESCRIPTION OF THE EMBODIMENT

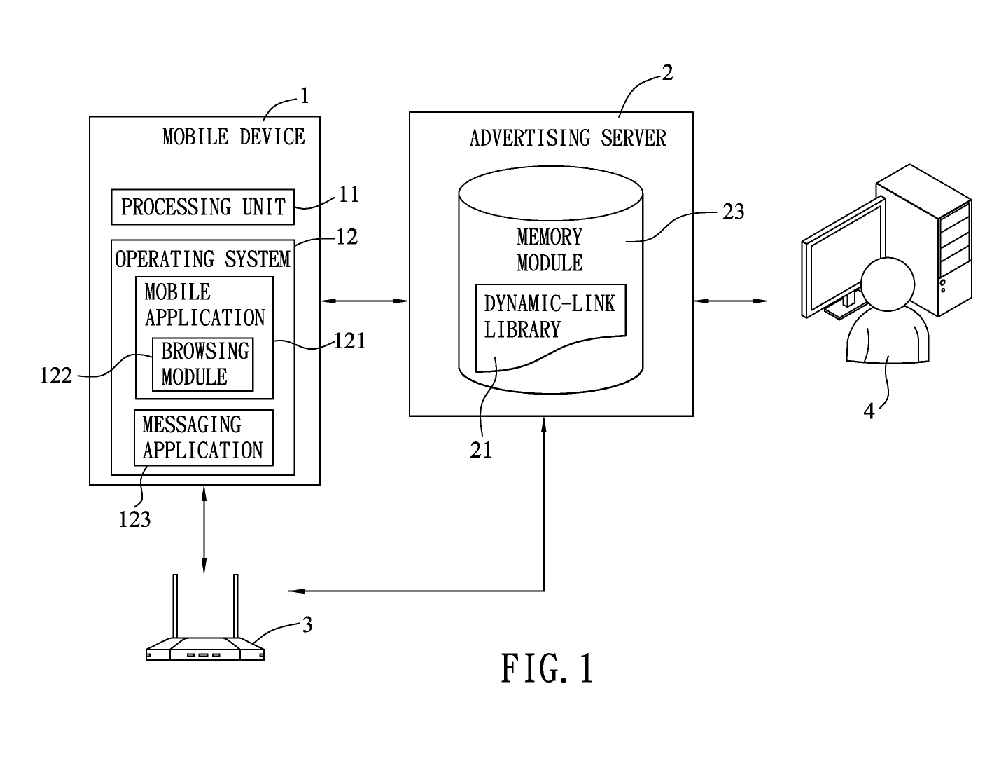

Referring to FIG. 1, the embodiment of the method for enabling a mobile device 1 to generate message feedback according to this disclosure is implemented using an advertising server 2. The advertising server 2 may communicate with the mobile device 1 via the internet or a telecommunication service provider 3, and may communicate with a host advertiser 4 via the internet. The telecommunication service provider 3 is able to receive a message (e.g., a text message) from the mobile device 1 and to transmit the message to the advertising server 2, and is also able to receive a message from the advertising server 2 and to transmit the message to the mobile device 1.

The mobile device 1 includes a processing unit 11 and is installed with an operating system 12 in which a mobile application 121 is installed. In this embodiment, the mobile application 121 is an application for a mobile phone, is associated with the advertising server 2, and includes a browsing module 122.

When the mobile application 121 is launched by the processing unit 11, the browsing module 122 is used by a user to browse an image frame provided by the mobile application 121. The image frame maybe that of a program application, a webpage or a game, and may be embedded with at least an advertising component corresponding to a website link that is associated with the advertising server 2.

The advertising component may be a banner ad or a push notification, which is an advertisement provided by the host advertiser 4 on an advertising network. The advertisement is brought by the advertising network into the image frame of the mobile application 121.

The advertising server 2 includes a memory module 23 that stores a dynamic-link library 21 therein. The dynamic-link library 21 contains information of a variety of models of different mobile devices 1, and a variety of message launching commands that respectively configure various models of mobile devices that have different versions of mobile operating systems (e.g., iOS, android, Windows phone series, etc.) to launch a corresponding messaging application 123, and may be packed to be a single program for saving system resources, and for facilitating subsequent updates and maintenance.

When the user uses the mobile application 121 through the mobile device 1, the browsing module 122 loads the advertising component that corresponds to the website link from the advertising server 2.

When the browsing module 122 detects a user click/touch on the advertising component of interest, the mobile device 1 transmits a request corresponding to the advertising component to the advertising server 2.

Upon receipt of the request, the advertising server 2 determines whether or not there is a landing page corresponding to the selected advertising component that is provided by the host advertiser 4.

When the determination is affirmative, the advertising server 2 obtains information of the landing page for causing the mobile device 1 to open the landing page using the browsing module 122. The landing page includes advertising information and a confirmation component associated with the advertising server 2. Note that the landing page may be built in the advertising server 2 or another server. In addition, upon receipt of the request corresponding to the advertising component, the advertising server 2 may calculate and record a click number and a conversion rate associated with the advertising component, so that the host advertiser 4 may be advised of effects of different advertising components provided in the same advertising activity.

For example, assuming that the website link corresponding to the advertising component is “http://mdsp.mobiinsight.com:8081/DSP.aspx?BannerID=141&NID=2”, the advertising server 2 may acquire the information of the corresponding landing page according to an identification code (i.e., BannerID) in the website link upon receipt of the request from the mobile device 1, and provide the landing page to the mobile device 1 for display using the browsing module 122 by redirecting.

When the user clicks the confirmation component in the landing page to express interest to the advertising information, the advertising server 2 receives from the mobile device 1 user agent data associated with the mobile device 1 upon detection of the click action by the browsing module 122. In addition, the advertising server 2 may calculate and record a click number and a conversion rate associated with the confirmation component, thereby making it possible for the host advertiser 4 to know how much the advertising information of the landing page interests the users.

When the determination is negative, i.e., the advertising server 2 directly identifies from the identification code (Banner ID) that no landing page corresponding to the advertising component is provided by the host advertiser 4, the advertising server 2 immediately receives from the mobile device 1 the user agent data associated with the mobile device 1.

Upon receipt of the user agent data, the advertising server 2 calls the dynamic-link library 21 to analyze the user agent data. The advertising server 2 uses the dynamic-link library 21 to analyze the operating system installed at the mobile device 1 and version information thereof, and selects and loads a message launching command conforming to the mobile device 1, a preset telephone port number and a preset text that are transmitted to the mobile device 1 accordingly. Note that the advertising server 2 is associated with a plurality of preset telephone port numbers, each corresponding to a respective advertisement, and the preset telephone port number that is transmitted to the mobile device 1 is associated with the advertisement that is of interest to the user of the mobile device 1.

Then, the browsing module 122 of the mobile device 1 executes the message launching command to activate a messaging application 123 of the mobile device 1, to automatically load the preset telephone port number into a recipient field of a messaging interface, and to automatically load the preset text into a content field of the messaging interface, thereby creating a feedback message. Thereafter, the user may send the feedback message to the advertising server 2 by operating the mobile device 1. In this embodiment, the feedback message also contains information of a phone number associated with the mobile device 1.

In this embodiment, the selected message launching command may be implemented using program syntax such as: smsto:?phonenumber=“0987654321”&body=“I am interested in xxx product. Please provide detailed information”. In the program syntax, “phonenumber” is used to place the preset telephone port number, and “body” is used to place the preset text, but the present disclosure is not limited in this respect. Program syntax of the message launching command may vary with the different operating systems installed at the mobile devices.

According to the preset telephone port number contained in the feedback message, the advertising server 2 may find the host advertiser 4 of the advertisement that corresponds to the preset telephone port number, transmit the phone number of the mobile device 1 to the host advertiser 4, and simultaneously transmit an acknowledgement message from the host advertiser 4 to the mobile device 1.

Accordingly, upon a user trigger (e.g., clicking/touching) of an advertisement displayed by the mobile device 1, messaging function that corresponds to the operating system (e.g., iOS, android, Windows Phone, etc.) or the brand of the mobile phone 1 (particularly, a smart phone) may thus be launched, and a text that corresponds to the advertising activity may be loaded from a variety of preset texts. The user only needs to trigger a “send” button of the messaging interface for expressing interest in the specific product shown in the landing page, or in the advertisement displayed by the mobile device 1. After completion of message transmission, the phone number of the user is automatically acquired by the advertising server 2, and the relevant information may be provided to the host advertiser 4 for subsequent sale activities or services.

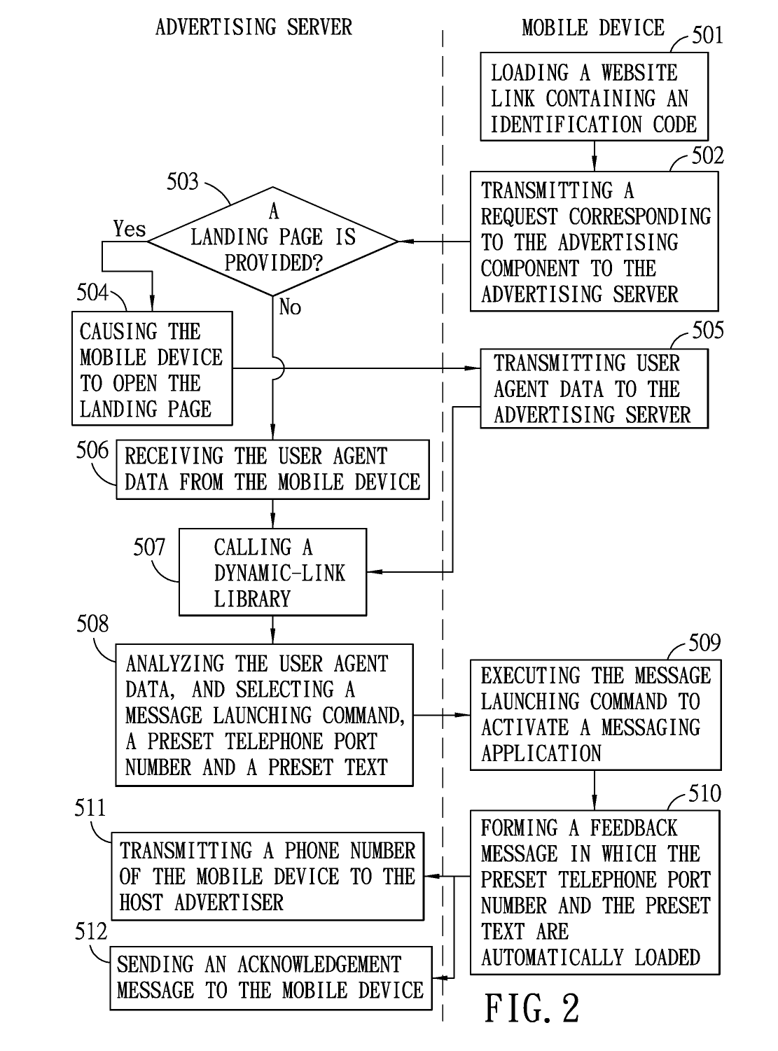

Referring to FIGS. 1 and 2, the method of this disclosure includes the following steps:

Step 501: The mobile device 1 loads a website link containing an identification code.

Step 502: Upon detection of a user trigger on an advertising component corresponding to the website link, the mobile device 1 transmits a request corresponding to the advertising component to the advertising server 2.

Step 503: In response to the request, the advertising server 2 determines whether or not there is a landing page corresponding to the advertising component that is provided by the host advertiser 4 according to the identification code contained in the website link. The flow goes to step 504 when the determination is affirmative, and goes to step 506 when otherwise.

Step 504: The advertising server 2 causes the mobile device 1 to open the landing page for display by the browsing module 122. The landing page contains advertising-associated information and a confirmation component.

Step 505: Upon detection of a user trigger on a confirmation component of the landing page by the browsing module 122, the mobile device 1 transmits user agent data associated with the mobile device 1 to the advertising server 2. The user agent data includes information of an operating system of the mobile device 1, and the information contains version information of the operating system.

Step 506: The advertising server 2 directly receives the user agent data from the mobile device 1 via the browsing module 122.

Step 507: The advertising server 2 calls a dynamic-link library 21 after receipt of the user agent data.

Step 508: The advertising server 2 uses the dynamic-link library 21 to analyze the user agent data, selects a message launching command, a preset telephone port number and a preset text from the memory module 23, and transmits the message launching command, the preset telephone port number and the preset text thus selected to the mobile device 1.

Step 509: The mobile device 1 executes the message launching command to active a messaging application thereof.

Step 510: The mobile device 1 automatically loads the preset telephone port number and the preset text into a recipient field and a content field of the messaging application, respectively, thereby forming a feedback message that is provided to the advertising server 2.

Step 511: The advertising server 2 obtains information of the host advertiser 4 according to the preset telephone port number, and transmits a phone number of the mobile device 1 to the host advertiser 4 via an API (application programming interface).

Step 512: The advertising server 2 obtains information of the host advertiser 4 according to the preset telephone port number, and sends an acknowledgement message to the mobile device 1.

In summary, the method and the advertising server 2 of the present disclosure enable the mobile device 1 to automatically launch the messaging application 123 after the user triggers the advertisement displayed by the mobile device 1, so as to obtain and provide the phone number of the mobile device 1 to the host advertiser 4 after confirmation from the user. The phone numbers thus obtained have an accuracy of 100% due to direct transmission by the mobile device 1, so that the call completion rate KPI may be promoted to 85% to 90%, which is much higher than the call completion rate KPI of 50% where the phone numbers are obtained by manual inputs of the users. In addition, the users may sufficiently express interests in specific advertising information and products by clicking/touching the advertisement displayed by the browsing module 122 of the mobile device 1 and actively sending the feedback message, which form a double opt-in process. Since the double opt-in process is independently completed by the user, privacy concerns of personal data may be avoided while maintaining quality of obtained name lists, thereby enhancing interest of host advertisers. Moreover, the triggering behavior of users may be used by the host advertisers 4 to analyze a trigger rate and a conversion rate of advertisements, thereby precisely determining effectiveness of advertisements.

While the present invention has been described in connection with what is considered the most practical embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A method for enabling a mobile device to generate message feedback, said method to be implemented by an advertising server, said method comprising the steps of:
(a) receiving, from a mobile device, user agent data associated with the mobile device subsequent to a user trigger of a website link that is associated with the advertising server and that is loaded by the mobile device, the advertising server including a memory module that stores a dynamic-link library, the dynamic-link library containing a variety of message launching commands which respectively configure a variety of mobile devices to launch a corresponding messaging application;
(b) calling the dynamic-link library, followed by analyzing the user agent data from the mobile device;
(c) based on a result of the analyzing, selecting, from the memory module, one of the message launching commands that conforms with the mobile device, a preset port number that is associated with the website link, and a preset text; and
(d) transmitting to the mobile device the message launching command, the preset port number, and the preset text selected in step (c),
wherein the message launching command configures the mobile device to launch a messaging application for creating a feedback message in which the preset port number is automatically loaded into a recipient field of the feedback message, and in which the preset text is automatically loaded into a content field of the feedback message.

2. The method as claimed in claim 1, wherein the user agent data includes information of an operating system of the mobile device, the information containing version information of the operating system.

3. The method as claimed in claim 1, wherein step (a) includes:
(a-1) receiving a request that corresponds to an advertising component displayed on the mobile device, the advertising component corresponding to the website link loaded by the mobile device, the request being generated in response to a user trigger action on the advertising component via the mobile device;
(a-2) in response to the request received in sub-step (a-1), causing the mobile device to open a landing page that contains advertising-associated information and a confirmation component; and
(a-3) receiving the user agent data subsequent to a user trigger of the confirmation component of the landing page.

4. The method as claimed in claim 1, wherein the advertising server is associated with a plurality of preset port numbers, each corresponding to a respective advertisement, the preset port number selected in step (c) being associated with an advertisement displayed by the mobile device, and the method further comprising the step of:
in response to receipt of the feedback message, transmitting contact information associated with the mobile device to a host advertiser to which the advertisement corresponds based upon the port number contained in the feedback message.

5. The method as claimed in claim 1, further comprising the step of:
sending an acknowledgement message to the mobile device in response to receipt of the feedback message.

6. An advertising server comprising a memory module that stores a dynamic-link library, said dynamic-link library containing a variety of message launching commands which respectively configure a variety of mobile devices to launch a corresponding messaging application, wherein:
said advertising server is configured to:
receive, from a mobile device, user agent data associated with the mobile device subsequent to a user trigger of a website link that is associated with said advertising server and that is loaded by the mobile device;
call said dynamic-link library, followed by analyzing the user agent data from the mobile device;
based on a result of the analyzing, select, from said memory module, one of the message launching commands that conforms with the mobile device, a preset port number that is associated with the website link, and a preset text; and
transmit to the mobile device the message launching command, the preset port number, and the preset text thus selected; and
the message launching command configures the mobile device to launch a messaging application for creating a feedback message in which the preset port number is automatically loaded into a recipient field of the feedback message, and in which the preset text is automatically loaded into a content field of the feedback message.

7. The advertising server as claimed in claim 6, wherein the user agent data includes information of an operating system of the mobile device, the information containing version information of the operating system.

8. The advertising server as claimed in claim 6, being further configured to:
receive a request that corresponds to an advertising component displayed on the mobile device, the advertising component corresponding to the website link loaded by the mobile device, the request being generated in response to a user trigger action on the advertising component via the mobile device,
in response to the request, cause the mobile device to open a landing page that contains advertising-associated information and a confirmation component, and
receive the user agent data subsequent to a user trigger of the confirmation component of the landing page.

9. The advertising server as claimed in claim 6, being associated with a plurality of preset port numbers, each corresponding to a respective advertisement, the preset port number selected thereby being associated with an advertisement displayed by the mobile device, wherein said advertising server is further configured to:
in response to receipt of the feedback message, transmit contact information associated with the mobile device to a host advertiser to which the advertisement corresponds based upon the port number contained in the feedback message.

10. The advertising server as claimed in claim 6, being further configured to send an acknowledgement message to the mobile device in response to receipt of the feedback message.
